(19) United States
(12) Patent Application Publication
(10) Pub. No.: US 2026/0112914 A1
(43) Pub. Date: Apr. 23, 2026

(54) CHARGING METHOD, CHARGING APPARATUS, AND ELECTRONIC DEVICE

(71) Applicant: Luxshare Precision Industry Company Limited, SHENZHEN (CN)

(72) Inventors: Shu-li XIA, SHENZHEN (CN); Guang-shun HE, SHENZHEN (CN); Xian-zhen LIU, SHENZHEN (CN)

(73) Assignee: Luxshare Precision Industry Company Limited, SHENZHEN (CN)

(21) Appl. No.: 19/022,803

(22) Filed: Jan. 15, 2025

(30) Foreign Application Priority Data
Oct. 21, 2024 (CN) 202411476586.9

(51) Int. Cl. H02J 7/00

(52) U.S. Cl. CPC H02J 7/94; H02J 7/96

(57) ABSTRACT

Provided are a charging method, a charging apparatus, and an electronic device. The method includes: collecting a charging current and a battery voltage of the to-be-charged device in real time; according to the charging current and the battery voltage collected during a constant-current charging phase, increasing a charging voltage according to a preset step voltage and controlling an increasing speed of the charging voltage; according to the charging current and the battery voltage collected during a constant-voltage charging phase, decreasing the charging voltage according to the preset step voltage; and charging the to-be-charged device according to the charging voltage and the charging current. With this solution, high-efficiency charging is implemented through the reduction of an energy loss.

### CROSS REFERENCE TO RELATED APPLICATION(S)

This application claims the priority to Chinese Patent Application No. CN202411476586.9, filed on Oct. 21, 2024, the disclosure of which is incorporated herein by reference in its entirety.

### TECHNICAL FIELD

Embodiments of the present disclosure relate to a charging field and, in particular, to a charging method, a charging apparatus, and an electronic device.

### BACKGROUND

In related art, Electronic products are growing in popularity. Electro-acoustic products, such as true wireless stereo (TWS) products, rely heavily on a charging technology. Typically, TWS products are supplemented with electricity through a charging case.

The charging case increases the battery voltage of the charging case through a boost integrated circuit (IC) directly and outputs a voltage of 5 V. Then, the charging case is connected to earphones through pogo pins. The earphones use a linear charging IC to supplement an earphone battery with electricity. However, the entire system suffers from relatively significant energy loss, resulting in less usable power for the earphones and relatively low charging efficiency of the entire system in most situations. As a result, the endurance of the product is insufficient.

### SUMMARY

The present disclosure provides a charging method, a charging apparatus, and an electronic device so that high-efficiency charging is implemented through the reduction of an energy loss.

Embodiments of the present disclosure provide a charging method. The charging method includes the steps below.

A charging current and a battery voltage of the to-be-charged device are collected in real time.

According to the charging current and the battery voltage collected during a constant-current charging phase, a charging voltage is increased according to a preset step voltage, and an increasing speed of the charging voltage is controlled.

According to the charging current and the battery voltage collected during a constant-voltage charging phase, the charging voltage is decreased according to the preset step voltage.

The to-be-charged device is charged based on the charging voltage and the charging current.

Optionally, the step in which, according to the charging current and the battery voltage collected during a constant-current charging phase, a charging voltage is increased according to a preset step voltage and an increasing speed of the charging voltage is controlled includes the steps below.

In response to the battery voltage being greater than the minimum battery voltage and the charging current being less than a target charging current, according to the preset step voltage, the charging voltage is increased stepwise from a preset initial constant-current charging voltage until the charging current reaches the target charging current.

The increasing speed of the charging voltage is controlled.

Optionally, the step in which the increasing speed of the charging voltage is controlled includes the step below.

In response to the charging current reaching the target charging current for the first time, a present charging voltage is decreased once according to the preset step voltage.

Optionally, the method further includes the step below.

After the charging current reaches the target charging current, in response to the charging current decreasing to less than the target charging current, the charging voltage is continuously increased stepwise according to the preset step voltage until the charging current reaches the target charging current again.

Optionally, the step in which, according to the charging current and the battery voltage collected during the constant-voltage charging phase, the charging voltage is decreased according to the preset step voltage includes the step below.

In response to the battery voltage being less than the maximum battery voltage and the charging current decreasing, the charging voltage is decreased stepwise to the target charging voltage according to the preset step voltage.

Optionally, before the step in which the charging voltage is increased according to a preset step voltage and according to the charging current and the battery voltage collected during a constant-current charging phase, and an increasing speed of the charging voltage is controlled, the charging method further includes the step below.

In a trickle charging phase, the charging voltage is set to a trickle charging voltage according to the charging current and the battery voltage.

Optionally, the constant-current charging phase includes multiple constant-current charging sub-phases arranged in sequence, each of the multiple constant-current charging sub-phases corresponds to a target charging current, and a target charging current corresponding to a previous constant-current charging sub-phase in the sequence is greater than a target charging current corresponding to a subsequent constant-current charging sub-phase in the sequence.

The step in which, according to the charging current and the battery voltage collected during the constant-current charging phase, the charging voltage is increased according to the preset step voltage and the increasing speed of the charging voltage is controlled includes the steps below.

In the first constant-current charging sub-phase, in response to the charging current being less than the first target charging current and the battery voltage being greater than the minimum battery voltage and less than the first battery voltage, the charging voltage is increased stepwise according to a first step voltage until the charging current reaches the first target charging current.

In the first constant-current charging sub-phase, the increasing speed of the charging voltage is controlled.

In a present constant-current charging sub-phase other than the first constant-current charging sub-phase, in response to the charging current being less than a previous target charging current and greater than a present target charging current and the battery voltage being greater than a previous battery voltage and less than a present battery voltage, the charging voltage is increased stepwise according to the present step voltage until the charging current decreases to the present target charging current.

The previous target charging current refers to a target charging current corresponding to a constant-current charging sub-phase previous to the present constant-current charging sub-phase. The present target charging current refers to a target charging current corresponding to the present constant-current charging phase. The previous battery voltage refers to a target battery voltage corresponding to the previous target charging current. The present battery voltage refers to a target battery voltage corresponding to the present target charging current. The present step voltage refers to a step voltage corresponding to the present constant-current charging sub-phase.

Optionally, the multiple constant-current charging sub-phases correspond to the same step voltage or different step voltages.

Embodiments of the present disclosure further provide a charging apparatus configured to perform the charging method described in the first aspect. The charging apparatus includes a collection module, a first-phase charging voltage control module, a second-phase charging voltage control module, and a charging module.

The collection module is configured to collect a charging current and a battery voltage of the to-be-charged device in real time.

The first-phase charging voltage control module is configured to, according to the charging current and the battery voltage collected during a constant-current charging phase, increase a charging voltage according to a preset step voltage and control an increasing speed of the charging voltage.

The second-phase charging voltage control module is configured to, according to the charging current and the battery voltage collected during a constant-voltage charging phase, decrease the charging voltage according to the preset step voltage.

The charging module is configured to charge the to-be-charged device based on the charging voltage and the charging current.

Embodiments of the present disclosure further provide an electronic device.

The electronic device includes one or more processors and a memory.

The memory is communicatively connected to the at least one processor.

The memory stores a computer program executable by the at least one processor, where the computer program is executed by the at least one processor to enable the at least one processor to perform the charging method described in the first aspect.

In the embodiments of the present disclosure, the charging current of the to-be-charged device and the battery voltage of the to-be-charged device are collected in real time; according to the charging current and the battery voltage collected during a constant-current charging phase, a charging voltage is increased according to a preset step voltage and an increasing speed of the charging voltage is controlled; according to the charging current and the battery voltage collected during a constant-voltage charging phase, the charging voltage is decreased according to the preset step voltage; and the to-be-charged device is charged according to the charging voltage and the charging current. Thus, in different charging phases, the charging voltage is varied in real time. A voltage difference between the charging voltage varied in real time and a real-time battery voltage remains relatively small, thereby minimizing an energy loss. Thus, the high-efficiency charging is implemented, and an energy loss caused by the charging voltage constantly remaining at a relatively high preset voltage value is avoided.

### BRIEF DESCRIPTION OF DRAWINGS

FIG. 1 is a flowchart of a charging method according to an embodiment of the present disclosure;

FIG. 2 is another flowchart of a charging method according to an embodiment of the present disclosure;

FIG. 3 is a graph showing variations of a voltage and a current with which a to-be-charged device is charged in different charging phases according to an embodiment of the present disclosure;

FIG. 4 is another graph showing variations of a voltage and a current with which a to-be-charged device is charged in different charging phases according to an embodiment of the present disclosure;

FIG. 5 is another graph showing variations of a voltage and a current with which a to-be-charged device is charged in different charging phases according to an embodiment of the present disclosure;

FIG. 6 is a structural diagram of a charging apparatus according to an embodiment of the present disclosure; and

FIG. 7 is a structural diagram of an electronic device according to an embodiment of the present disclosure.

### DETAILED DESCRIPTION

The present disclosure is described below in detail in conjunction with drawings and embodiments. It is to be understood that the embodiments described herein are intended to explain the present disclosure and not to limit the present disclosure. Additionally, it is to be noted that for ease of description, only part, not all, of the structures related to the present disclosure are illustrated in the drawings.

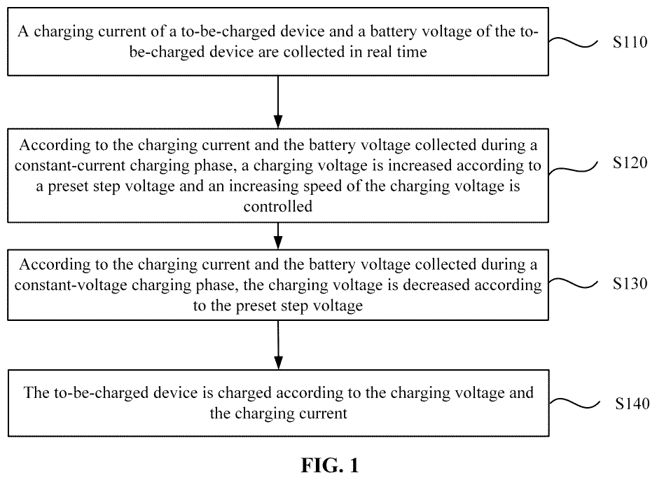

FIG. 1 is a flowchart of a charging method according to an embodiment of the present disclosure. This embodiment is applicable to the case where a to-be-charged device is charged. The method may be performed by a charging apparatus. As shown in FIG. 1, the method specifically includes the steps below.

In S110, a charging current of a to-be-charged device and a battery voltage of the to-be-charged device are collected in real time.

In this embodiment, the charging apparatus may communicate with the to-be-charged device. The to-be-charged device may send a battery voltage and a charging current of an internal battery of the to-be-charged device through a status instruction in a preset period. The charging apparatus collects the battery voltage and the charging current according to the preset period. The preset period is determined through a communication frequency between the charging apparatus and the to-be-charged device. For example, the preset period may be 2 ms to 3 ms.

In a charging process of the to-be-charged device, charging phases of the to-be-charged device include a constant-current charging phase and a constant-voltage charging phase. In the constant-current charging phase, the charging current of the to-be-charged device remains constant, and the battery voltage of the to-be-charged device increases continuously until the requirement is met that the to-be-charged device is fully charged. In the constant-voltage charging phase, the battery voltage of the to-be-charged device remains constant, and the charging current of the to-be-charged device gradually decreases. In this embodiment, a voltage detection apparatus is configured to receive battery voltages of the to-be-charged device in different charging phases in real time, and a current detection apparatus is configured to receive charging currents of the to-be-charged device in different charging phases in real time.

In S120, according to the charging current and the battery voltage collected during a constant-current charging phase, a charging voltage is increased according to a preset step voltage and an increasing speed of the charging voltage is controlled.

The charging voltage is increased according to the preset step voltage, which refers to that a certain initial threshold is used as an initial charging voltage and the charging voltage is continuously increased stepwise according to the preset step voltage. The magnitude of the preset step voltage may be determined according to the real-time battery voltage and the real-time charging current.

The increasing speed of the charging voltage is controlled during the increase of the charging voltage, which refers to that the time required by the charging voltage to reach the maximum value is controlled. In a charging process, the charging voltage should remain higher than the battery voltage, thereby avoiding overcharging and a waste of efficiency caused by overcharging.

It is to be understood that it is ensured that the voltage difference between each charging voltage increased according to the preset step voltage and the real-time battery voltage is within a range greater than 0, thereby ensuring a basic charging requirement of the to-be-charged device. As the charging voltage is outputted, the battery voltage of the to-be-charged device is continuously increased to a target charging voltage. In addition, in this charging process, the to-be-charged device is charged with a constant charging current.

In S130, according to the charging current and the battery voltage collected during a constant-voltage charging phase, the charging voltage is decreased according to the preset step voltage.

The charging voltage is decreased according to the preset step voltage, which refers to that the final charging voltage of a constant-current charging phase is used as an initial charging voltage and the charging voltage is continuously decreased stepwise according to the preset step voltage. The magnitude of the preset step voltage may be determined based on a real-time battery voltage and a real-time charging current in the constant-voltage charging phase.

In the constant-voltage charging phase, as the charging voltage decreases, the charging current of the to-be-charged device continuously decreases in this charging process, and the voltage of the to-be-charged device remains at a value which meets the requirement that the to-be-charged device is fully charged.

In S140, the to-be-charged device is charged according to the charging voltage and the charging current.

In the related art, in a constant-current charging phase, charging is constantly performed with a charging current and a constant charging voltage, and in a constant-voltage charging phase, charging is performed with a charging current and the constant charging voltage in the constant-current charging phase. The difference between the constant charging voltage and a real-time battery voltage in different phases is relatively large. However, in this embodiment, the charging voltage in the constant-current charging phase is increased stepwise, and the difference between the charging voltage increased stepwise and the real-time battery voltage is relatively small. Thus, when the to-be-charged device is charged according to the charging voltage and the charging current (the charging current is the same as the charging current in the constant-current charging phase in the related art) in the constant-current charging phase, an energy loss in the constant-voltage charging phase is reduced. The charging voltage in the constant-voltage charging phase is decreased stepwise, and the difference between the charging voltage decreased stepwise and the real-time battery voltage is relatively small. Thus, when the to-be-charged device is charged according to the charging voltage and the charging current (the charging current is the same as the charging current in the constant-voltage charging phase in the related art) in the constant-voltage charging phase, the energy loss in the constant-voltage charging phase is also reduced. Thus, an energy loss in the entire charging phase is reduced.

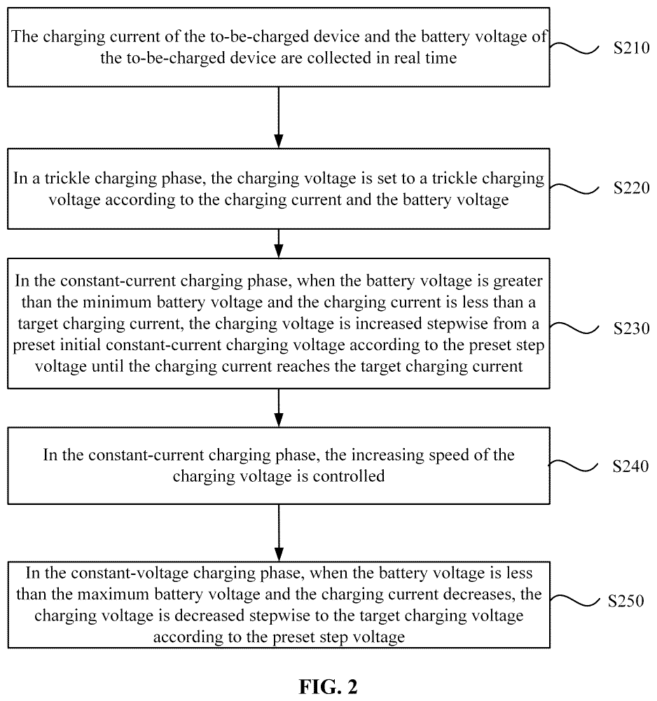

Optionally, this embodiment is further detailed and optimized based on the preceding embodiment. FIG. 2 is another flowchart of a charging method according to the embodiment of the present disclosure. As shown in FIG. 2, the method specifically includes the steps below.

In S210, the charging current of the to-be-charged device and the battery voltage of the to-be-charged device are collected in real time.

In S220, in a trickle charging phase, the charging voltage is set to a trickle charging voltage according to the charging current and the battery voltage.

In the charging process of the to-be-charged device, different charging phases may further include a trickle charging phase. The trickle charging phase is generally previous to the constant-current charging phase. In the trickle charging phase, the battery is restoratively charged after the battery is fully discharged. If the battery is not fully discharged, the trickle charging phase is not necessary. The step in which in the trickle charging phase, the charging voltage is set to the trickle charging voltage according to the charging current and the battery voltage includes: when the battery voltage is less than the minimum battery voltage, the charging voltage is set to the trickle charging voltage, the charging current is set to a trickle charging current, and the trickle charging voltage and the trickle charging current are outputted to the to-be-charged device.

The minimum battery voltage V1 is the minimum standard voltage of the to-be-charged device. When the battery voltage is less than the minimum standard voltage, the to-be-charged device cannot start working, and it may be considered that the battery of the to-be-charged device is fully discharged. For example, if the to-be-charged device is Bluetooth earphones, a first preset voltage may be 3.1 V.

The trickle charging current I1 is a default trickle current of the to-be-charged device. The default trickle current is generally 20 mA to 30 mA. In the trickle charging phase, the to-be-charged device is charged with the trickle charging current, which mainly aims to maintain the capacity of the battery in the to-be-charged device. The electronic activity inside the battery is maintained so that the case is avoided where the battery is not used for a long period of time and loses activity, resulting in a decrease in capacity.

The trickle charging voltage Va is determined by the line loss from the output terminal of an electronic device to the inside of the to-be-charged device and a charging voltage for the to-be-charged device to be fully charged. For example, if the to-be-charged device is Bluetooth earphones, the trickle charging voltage may be 4.7 V.

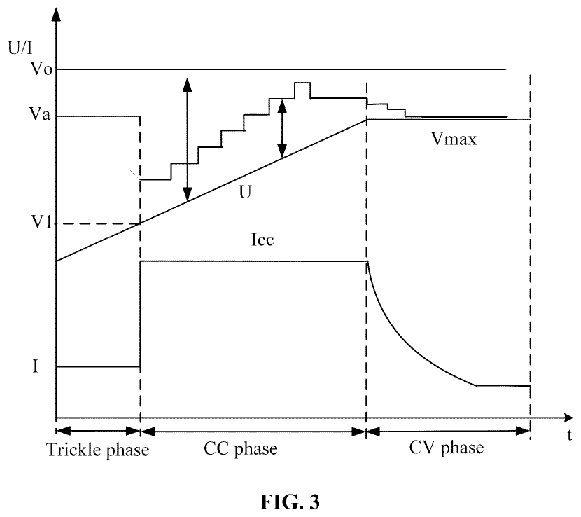

FIG. 3 is a graph showing variations of a voltage and a current with which the to-be-charged device is charged in the different charging phases according to an embodiment of the present disclosure. As shown in FIG. 3, in the charging process of the to-be-charged device, the different charging phases include the trickle charging phase, the constant-current (CC) charging phase, and the constant-voltage (CV) charging phase. When the real-time battery voltage is less than the minimum battery voltage V1, the trickle charging voltage Va is outputted to the to-be-charged device, and the to-be-charged device is controlled to be charged with the trickle charging current I1. Thus, the to-be-charged device enters the trickle charging phase.

In S230, in the constant-current charging phase, when the battery voltage is greater than the minimum battery voltage and the charging current is less than a target charging current, the charging voltage is increased stepwise from a preset initial constant-current charging voltage according to the preset step voltage until the charging current reaches the target charging current.

The constant-current charging phase corresponds to a target constant current Icc. The target constant current Icc is determined by a target charging voltage of the to-be-charged device and a required charging time of the to-be-charged device. The target charging voltage Vmax refers to the charging voltage for the to-be-charged device to be fully charged.

In the constant-current charging phase, the charging voltage is increased stepwise from the preset initial constant-current charging voltage according to the preset step voltage. The initial constant-current charging voltage is generally 4.4 V. The magnitude of the preset step voltage is related to the target constant current Icc. It is to be understood that when the required charging time is relatively short (the increasing speed of the preset step voltage is relatively high), the target constant current Icc is set to be relatively large and the corresponding preset step voltage may be relatively high. For example, the preset step voltage may be 50 mV.

In S240, in the constant-current charging phase, the increasing speed of the charging voltage is controlled.

Specifically, the step in which the increasing speed of the charging voltage is controlled includes: when the charging current reaches the target charging current Icc for the first time, a present charging voltage is decreased once according to the preset step voltage. That is, when the real-time charging current reaches the target constant current Icc, a decreased preset step voltage is outputted according to a final charging voltage increased stepwise. In this manner, a voltage configuration can be prevented from increasing too quickly and resulting in a waste of efficiency. In addition, a minimal energy loss can be ensured when the to-be-charged device is supplemented with electricity at the maximum current.

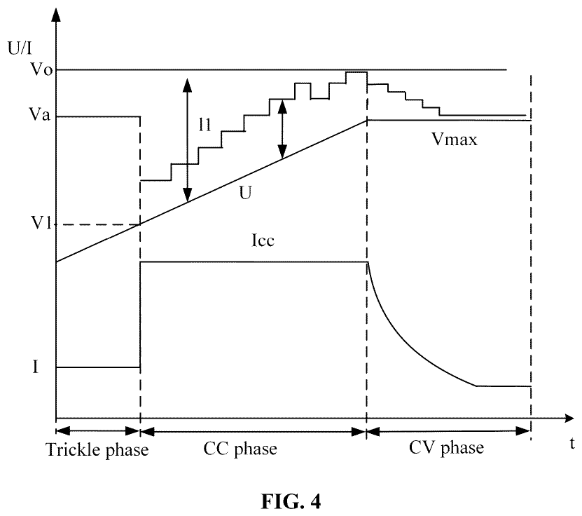

In other embodiments, it is considered that after the target constant current Icc is reached, when the present charging voltage approximates the voltage of the to-be-charged device which is fully charged, the target constant current Icc dynamically varies, that is, the target charging current decreases to less than the target charging current Icc. FIG. 4 is another graph showing variations of a voltage and a current with which the to-be-charged device is charged in the different charging phases according to an embodiment of the present disclosure. Referring to FIG. 4, after the charging current reaches the target charging current Icc, when the charging current decreases to less than the target charging current Icc, the charging voltage is continuously increased stepwise according to the preset step voltage until the charging current reaches the target charging current Icc again. Thus, the dynamic variation of the target constant current Icc is prevented from causing the to-be-charged device to be insufficiently charged. The preset step voltage in this phase is determined according to the fluctuation of the target constant current Icc.

In S250, in the constant-voltage charging phase, when the battery voltage is less than the maximum battery voltage and the charging current decreases, the charging voltage is decreased stepwise to the target charging voltage according to the preset step voltage.

Referring to FIGS. 3 and 4, in the constant-voltage charging phase (the CV phase), the charging voltage is decreased stepwise, which refers to that the final voltage in the constant-current charging phase is used as an initial voltage and is decreased to the target charging voltage Vmax according to the preset step voltage. The target charging voltage Vmax is the charging voltage for the to-be-charged device to be fully charged. As the voltage decreased stepwise is outputted, the charging current of the to-be-charged device is continuously decreased in the charging process.

In this embodiment, specifically, the trickle charging voltage is outputted in the trickle charging phase, and the voltage increased stepwise is outputted in the constant-current charging phase. The difference between each voltage increased stepwise and the real-time battery voltage is smaller than the difference between the high charging voltage Vo constantly outputted and the real-time battery voltage in the related art. Thus, the energy loss in the constant-voltage charging phase is reduced. Similarly, the voltage decreased stepwise is outputted in the constant-voltage charging phase. The difference between each voltage decreased stepwise and the real-time battery voltage is apparently smaller than the difference between the charging voltage Vo constantly outputted and the real-time battery voltage in the related art. Thus, the energy loss in the constant-voltage charging phase is reduced. Thus, the energy loss in the entire charging phase is reduced.

In addition, it is to be noted that in some embodiments, to increase charging efficiency, the constant-current charging phase may include multiple constant-current charging sub-phases arranged in sequence. In the following embodiment, the charging voltage in the constant-current charging voltage is specifically described below in conjunction with the multiple constant-current charging sub-phases arranged in sequence. Each of the multiple constant-current charging sub-phases corresponds to a target charging current. A target charging current Icc corresponding to a previous constant-current charging sub-phase in the sequence is greater than a target charging current Icc corresponding to a subsequent constant-current charging sub-phase in the sequence.

Step S120 in which, according to the charging current and the battery voltage collected during a constant-current charging phase, a charging voltage is increased according to a preset step voltage and an increasing speed of the charging voltage is controlled includes the steps below.

In the first constant-current charging sub-phase, if the charging current is less than the first target charging current and the battery voltage is greater than the minimum battery voltage and less than the first battery voltage, the charging voltage is increased stepwise according to a first step voltage until the charging current reaches the first target charging current.

In the first constant-current charging sub-phase, the increasing speed of the charging voltage is controlled.

In a present constant-current charging sub-phase other than the first constant-current charging sub-phase, if the charging current is less than a previous target charging current and greater than a present target charging current and the battery voltage is greater than a previous battery voltage and less than a present battery voltage, the charging voltage is increased stepwise according to the present step voltage until the charging current decreases to the present target charging current.

The previous target charging current refers to a target charging current corresponding to a constant-current charging sub-phase previous to the present constant-current charging sub-phase. The present target charging current refers to a target charging current corresponding to the present constant-current charging sub-phase. The previous battery voltage refers to a target battery voltage corresponding to the previous target charging current. The present battery voltage refers to a target battery voltage corresponding to the present target charging current. The present step voltage refers to a step voltage corresponding to the present constant-current charging phase.

In the first constant-current charging sub-phase, the increasing speed of the charging voltage is controlled. That is, in the first constant-current charging sub-phase, after the charging voltage is increased stepwise according to the step voltage in the first constant-current charging sub-phase, voltage decrease needs to be performed once, thereby avoiding energy waste.

Optionally, the multiple constant-current charging sub-phases correspond to the same step voltage or different step voltages.

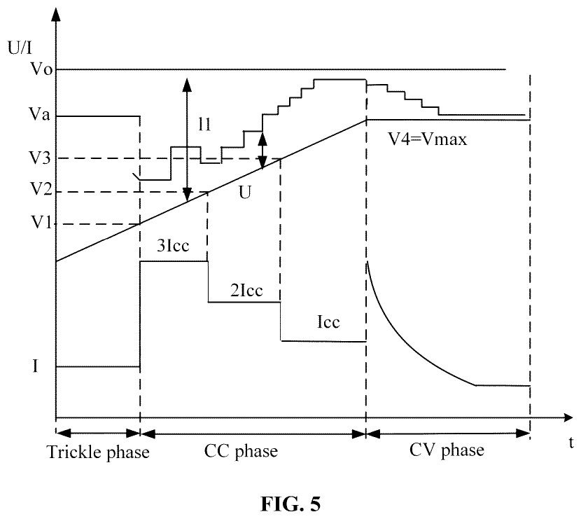

For example, FIG. 5 is a graph showing variations of a voltage and a current with which the to-be-charged device is charged in the different charging phases according to an embodiment of the present disclosure. As shown in FIG. 5, there are three constant-current charging sub-phases. The first target charging current, that is, the target charging current corresponding to the first constant-current charging sub-phase is 3Icc; the second target charging current, that is, the target charging current corresponding to the second constant-current charging sub-phase is 2Icc; the third target charging current, that is, the target charging current corresponding to the third constant-current charging sub-phase is Icc. Correspondingly, the first battery voltage is the target battery voltage corresponding to the first target charging current 3Icc and may be V2; the second battery voltage is the target battery voltage corresponding to the second target charging current 2Icc and may be V3; the third battery voltage is the target battery voltage corresponding to the third target charging current Icc and may be V4 (V4=Vmax).

In the first constant-current charging sub-phase, the charging current is less than the first target charging current 3Icc, and the battery voltage is greater than the minimum battery voltage V1 and less than the first battery voltage V2. The charging voltage is increased stepwise according to the first step voltage until the charging current reaches the first target charging current 3Icc. In the first constant-current charging sub-phase, after the charging voltage is increased stepwise according to the step voltage in the first constant-current charging sub-phase, the voltage decrease needs to be performed once.

In the second constant-current charging sub-phase, if the charging current is less than the first target charging current 3Icc and greater than the second target charging current 2Icc and the battery voltage is greater than the first battery voltage V2 and less than the second battery voltage V3, the charging voltage is increased stepwise according to the second step voltage until the charging current decreases to the second target charging current 2Icc.

In the third constant-current charging sub-phase, if the charging current is less than the second target charging current 2Icc and greater than the third target charging current Icc and the battery voltage is greater than the second battery voltage V3 and less than the third battery voltage V4 (V4=Vmax), the charging voltage is increased stepwise according to the third step voltage until the charging current decreases to the third target charging current Icc.

Different target charging currents are provided so that the battery is quickly charged and damage to the battery can be avoided. Thus, the charging efficiency is improved and battery health is ensured.

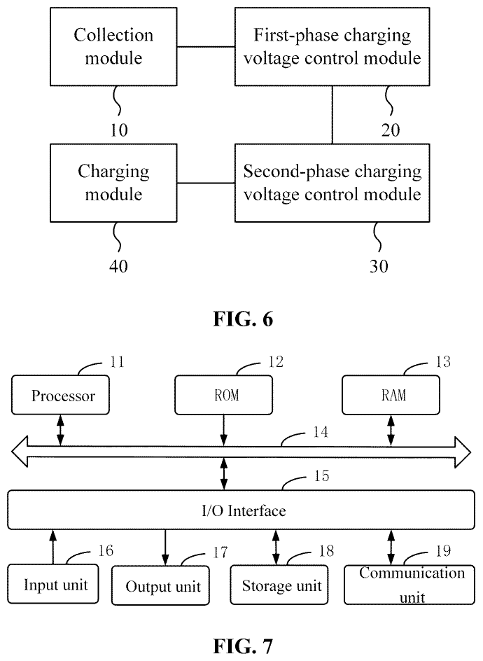

Embodiments of the present disclosure further provide a charging apparatus configured to perform the charging method described above. The apparatus has the same beneficial effects as the preceding embodiment. FIG. 6 is a structural diagram of the charging apparatus according to an embodiment of the present disclosure. As shown in FIG. 6, the charging apparatus includes a collection module 10, a first-phase charging voltage control module 20, a second-phase charging voltage control module 30, and a charging module 40.

The collection module 10 is configured to collect a charging current of a to-be-charged device and a battery voltage of the to-be-charged device in real time.

The first-phase charging voltage control module 20 is configured to, according to the charging current and the battery voltage collected during a constant-current charging phase, increase a charging voltage according to a preset step voltage and control an increasing speed of the charging voltage.

The second-phase charging voltage control module 30 is configured to, according to the charging current and the battery voltage collected during a constant-voltage charging phase, decrease the charging voltage according to the preset step voltage.

The charging module 40 is configured to charge the to-be-charged device according to the charging voltage and the charging current.

Based on the same inventive concept, embodiments of the present disclosure further provide an electronic device. The electronic device may be integrated into a charging case and/or Bluetooth earphones. FIG. 7 is a structural diagram of the electronic device according to an embodiment of the present disclosure. As shown in FIG. 7, the electronic device includes at least one processor 11 and a memory communicatively connected to the at least one processor 11, for example, a read-only memory (ROM) 12 or a random-access memory (RAM) 13. The memory stores a computer program executable by the at least one processor. The processor 11 may perform various appropriate actions and processing in accordance with the computer program stored in the ROM 12 or the computer program loaded into the RAM 13 from a storage unit 18. Various programs and data required for the operation of the electronic device may also be stored in the RAM 13. The processor 11, the ROM 12, and the RAM 13 are connected to each other through a bus 14. An input/output (I/O) interface 15 is also connected to the bus 14.

Multiple components in the electronic device 001 are connected to the I/O interface 15. The multiple components include an input unit 16 such as a keyboard or a mouse, an output unit 17 such as various types of displays, the storage unit 18 such as a magnetic disk or an optical disk, and a communication unit 19 such as a network card, a modem, or a wireless communication transceiver. The communication unit 19 allows the electronic device to exchange information/data with other devices over a computer network such as the Internet and/or various telecommunications networks.

The processor 11 may be various general-purpose and/or special-purpose processing components having processing and computing capabilities. Examples of the processor 11 include, but are not limited to, a central processing unit (CPU), a graphics processing unit (GPU), various special-purpose artificial intelligence (AI) computing chips, various processors executing machine learning models and algorithms, a digital signal processor (DSP), and any appropriate processor, controller, and microcontroller. The processor 11 performs the various methods and processing described above, for example, the charging method.

In some embodiments, the charging method may be implemented as computer programs tangibly contained in a computer-readable storage medium such as the storage unit 18. In some embodiments, part or all of computer programs may be loaded and/or installed onto the electronic device via the ROM 12 and/or the communication unit 19. When the computer programs are loaded to the RAM 13 and executed by the processor 11, one or more steps of the charging method described above may be performed. Alternatively, in other embodiments, the processor 11 may be configured, in any other appropriate manner (for example, by means of firmware), to perform the charging method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. These embodiments may include implementations in one or more computer programs. The one or more computer programs may be executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

It is to be noted that the preceding are only preferred embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A charging method, comprising:
collecting a charging current and a battery voltage of a to-be-charged device in real time;
according to the charging current and the battery voltage collected during a constant-current charging phase, increasing a charging voltage according to a preset step voltage and controlling an increasing speed of the charging voltage;
according to the charging current and the battery voltage collected during a constant-voltage charging phase, decreasing the charging voltage according to the preset step voltage; and
charging the to-be-charged device according to the charging voltage and the charging current.

2. The charging method according to claim 1, wherein according to the charging current and the battery voltage collected during the constant-current charging phase, increasing the charging voltage according to the preset step voltage and controlling the increasing speed of the charging voltage comprises:
in response to the battery voltage being greater than a minimum battery voltage and the charging current being less than a target charging current, according to the preset step voltage, increasing the charging voltage stepwise from a preset initial constant-current charging voltage until the charging current reaches the target charging current; and
controlling the increasing speed of the charging voltage.

3. The charging method according to claim 2, wherein controlling the increasing speed of the charging voltage comprises:
in response to the charging current reaching the target charging current for a first time, decreasing a present charging voltage once according to the preset step voltage.

4. The charging method according to claim 3, further comprising:
after the charging current reaches the target charging current, in response to the charging current decreasing to less than the target charging current, continuously increasing the charging voltage stepwise according to the preset step voltage until the charging current reaches the target charging current again.

5. The charging method according to claim 1, wherein according to the charging current and the battery voltage collected during the constant-voltage charging phase, decreasing the charging voltage according to the preset step voltage comprises:
in response to the battery voltage being less than a maximum battery voltage and the charging current decreasing, decreasing the charging voltage stepwise to the target charging voltage according to the preset step voltage.

6. The charging method according to claim 1, before increasing the charging voltage according to a preset step voltage and according to the charging current and the battery voltage collected during a constant-current charging phase, and controlling an increasing speed of the charging voltage, further comprises:
in a trickle charging phase, setting the charging voltage to a trickle charging voltage according to the charging current and the battery voltage.

7. The charging method according to claim 1, wherein the constant-current charging phase comprises a plurality of constant-current charging sub-phases arranged in sequence, each of the plurality of constant-current charging sub-phases corresponds to a target charging current, and a target charging current corresponding to a previous constant-current charging sub-phase in the sequence is greater than a target charging current corresponding to a subsequent constant-current charging sub-phase in the sequence; and
according to the charging current and the battery voltage collected during the constant-current charging phase, increasing the charging voltage according to the preset step voltage and controlling the increasing speed of the charging voltage comprises:
in a first constant-current charging sub-phase, in response to the charging current being less than a first target charging current and the battery voltage being greater than a minimum battery voltage and less than a first battery voltage, increasing the charging voltage stepwise according to a first step voltage until the charging current reaches the first target charging current;
in the first constant-current charging sub-phase, controlling the increasing speed of the charging voltage; and
in a present constant-current charging sub-phase other than the first constant-current charging sub-phase, in response to the charging current being less than a previous target charging current and greater than a present target charging current and the battery voltage being greater than a previous battery voltage and less than a present battery voltage, increasing the charging voltage stepwise according to the present step voltage until the charging current decreases to the present target charging current;
wherein the previous target charging current refers to a target charging current corresponding to a constant-current charging sub-phase previous to the present constant-current charging sub-phase, the present target charging current refers to a target charging current corresponding to the present constant-current charging sub-phase; the previous battery voltage refers to a target battery voltage corresponding to the previous target charging current, the present battery voltage refers to a target battery voltage corresponding to the present target charging current, and the present step voltage refers to a step voltage corresponding to the present constant-current charging sub-phase.

8. The charging method according to claim 7, wherein the plurality of constant-current charging sub-phases correspond to a same step voltage or different step voltages.

9. An electronic device, comprising:
at least one processor; and
a memory communicatively connected to the at least one processor;
wherein the memory stores a computer program executable by the at least one processor, wherein the computer program is executed by the at least one processor to enable the at least one processor to perform:
collecting a charging current and a battery voltage of a to-be-charged device in real time;
according to the charging current and the battery voltage collected during a constant-current charging phase, increasing a charging voltage according to a preset step voltage and controlling an increasing speed of the charging voltage;
according to the charging current and the battery voltage collected during a constant-voltage charging phase, decreasing the charging voltage according to the preset step voltage; and
charging the to-be-charged device according to the charging voltage and the charging current.

10. The electronic device according to claim 9, wherein according to the charging current and the battery voltage collected during the constant-current charging phase, the at least one processor is configured to increase the charging voltage according to the preset step voltage and control the increasing speed of the charging voltage by:
in response to the battery voltage being greater than a minimum battery voltage and the charging current being less than a target charging current, according to the preset step voltage, increasing the charging voltage stepwise from a preset initial constant-current charging voltage until the charging current reaches the target charging current; and
controlling the increasing speed of the charging voltage.

11. The electronic device according to claim 10, wherein the at least one processor is configured to control the increasing speed of the charging voltage by:
in response to the charging current reaching the target charging current for a first time, decreasing a present charging voltage once according to the preset step voltage.

12. The electronic device according to claim 11, wherein the at least one processor is configured to perform:
after the charging current reaches the target charging current, in response to the charging current decreasing to less than the target charging current, continuously increasing the charging voltage stepwise according to the preset step voltage until the charging current reaches the target charging current again.

13. The electronic device according to claim 9, wherein according to the charging current and the battery voltage collected during the constant-voltage charging phase, the at least one processor is configured to decrease the charging voltage according to the preset step voltage by:
in response to the battery voltage being less than a maximum battery voltage and the charging current decreasing, decreasing the charging voltage stepwise to the target charging voltage according to the preset step voltage.

14. The electronic device according to claim 9, wherein before increasing the charging voltage according to a preset step voltage and according to the charging current and the battery voltage collected during a constant-current charging phase and controlling an increasing speed of the charging voltage, the at least one processor is further configured to:
in a trickle charging phase, setting the charging voltage to a trickle charging voltage according to the charging current and the battery voltage.

15. The electronic device according to claim 9, wherein the constant-current charging phase comprises a plurality of constant-current charging sub-phases arranged in sequence, each of the plurality of constant-current charging sub-phases corresponds to a target charging current, and a target charging current corresponding to a previous constant-current charging sub-phase in the sequence is greater than a target charging current corresponding to a subsequent constant-current charging sub-phase in the sequence; and
according to the charging current and the battery voltage collected during the constant-current charging phase, the at least one processor is configured to increase the charging voltage according to the preset step voltage and control the increasing speed of the charging voltage by:
in a first constant-current charging sub-phase, in response to the charging current being less than a first target charging current and the battery voltage being greater than a minimum battery voltage and less than a first battery voltage, increasing the charging voltage stepwise according to a first step voltage until the charging current reaches the first target charging current;
in the first constant-current charging sub-phase, controlling the increasing speed of the charging voltage; and
in a present constant-current charging sub-phase other than the first constant-current charging sub-phase, in response to the charging current being less than a previous target charging current and greater than a present target charging current and the battery voltage being greater than a previous battery voltage and less than a present battery voltage, increasing the charging voltage stepwise according to the present step voltage until the charging current decreases to the present target charging current;
wherein the previous target charging current refers to a target charging current corresponding to a constant-current charging sub-phase previous to the present constant-current charging sub-phase, the present target charging current refers to a target charging current corresponding to the present constant-current charging sub-phase; the previous battery voltage refers to a target battery voltage corresponding to the previous target charging current, the present battery voltage refers to a target battery voltage corresponding to the present target charging current, and the present step voltage refers to a step voltage corresponding to the present constant-current charging sub-phase.

16. The electronic device according to claim 15, wherein the plurality of constant-current charging sub-phases correspond to a same step voltage or different step voltages.
